(19) United States
(12) Patent Application Publication
(10) Pub. No.: US 2019/0249486 A1
(43) Pub. Date: Aug. 15, 2019

(54) INSULATING GLASS UNIT PLUG AND INSTALLATION METHOD

(71) Applicant: GED INTEGRATED SOLUTIONS, INC., Glenwillow, OH (US)

(72) Inventor: William A. Briese, Hinckley, OH (US)

(21) Appl. No.: 16/273,909

(22) Filed: Feb. 12, 2019

Related U.S. Application Data
(60) Provisional application No. 62/629,785, filed on Feb. 13, 2018.

(51) Int. Cl. E06B 3/673

(52) U.S. Cl. CPC E06B 3/67308; E06B 3/6736; E06B 3/67352; E06B 3/67321

(57) ABSTRACT

A threaded insulating glass unit plug for sealing an aperture in a spacer frame of an insulating glass unit, method of assembly and installation is provided. The threaded insulating glass unit plug includes a head integrally formed with threaded body. The head has a recess formed for engaging a tool for installation during use. The body includes a cylindrical portion and a conical portion, the cylindrical portion spacing the conical portion from the head. A plurality of threads extend along the entire length of cylindrical portion.

### CROSS REFERENCES TO RELATED APPLICATIONS

The following application claims priority under 35 U.S.C. § 119(e) to U.S. Provisional Patent Application Ser. No. 62/629,785 filed Feb. 13, 2018 entitled INSULATING GLASS UNIT PLUG AND INSTALLATION METHOD. The above-identified application is incorporated herein by reference in its entirety for all purposes.

### TECHNICAL FIELD

The present disclosure relates to an insulating glass unit plug and installation method, and more particularly, a threaded insulating glass unit plug constructed for orientation filtering, allowing automatic installation.

### BACKGROUND

Construction of insulating glass units (hereinafter plural “IGUs” and singular “IGU”) generally involves forming a spacer frame by roll-forming a flat metal strip into an elongated hollow rectangular tube or “U” shaped channel. Generally, a desiccant material is placed within the rectangular tube or channel, and some provisions are made for the desiccant to come into fluid communication with or otherwise affect the interior space of the insulated glass unit. The elongated tube or channel is notched to allow the channel to be formed into a rectangular frame (hereinafter “spacer frame”). Generally, a sealant is applied to the outer three sides of the spacer frame in order to bond a pair of glass panes to either opposite sides of the spacer frame. Existing heated sealants include hot melts and dual seal equivalents (DSE). The pair of glass panes are positioned on the spacer frame to form a pre-pressed insulating glass unit. Generally, the pre-pressed insulating glass unit is passed through an IGU oven to melt or activate the sealant. The pre-pressed IGU is then passed through a press that applies pressure to the glass and sealant and compresses the IGU to a selected pressed unit thickness.

Manufacturers may produce IGUs having a variety of different glass types, different glass thicknesses, and different overall IGU thicknesses. The amount of heat required to melt the sealant of an IGU varies with the type of glass used for each pane of the IGU. Thicker glass panes and glass panes having low-E coatings have lower transmittance (higher opacities) than a thinner or clear glass pane (opacity is inversely proportional to transmittance). Less energy passes through a pane of an IGU having a high reflectance and low transmittance. As a result, more energy is required to heat the sealant of an IGU with panes that have higher reflectance and lower transmittance. For example, less energy is required to heat the sealant of an IGU with two panes of clear, single strength glass than is required to heat the sealant of an IGU with one pane of clear, double strength glass and one pane of low-E coated double strength glass.

Typically, an IGU has a pre-drilled or punched aperture hole, which is used to vent and balance the internal pressure of the IGU during the oven heating process. The aperture is also used to fill the IGU with gas to improve the insulation properties of the unit. Once the IGU is filled with gas, a rivet or fastener such as a screw is placed into the hole to form a first seal, then a hot sealant acting as a second seal is manually applied with a putty knife or trowel along the spacer frame perimeter by an operator.

Further discussion relating to the types of IGUs and spacer frames and methods and equipment used to fabricate the IGUs and spacer frames is discussed in U.S. Patent Publication Nos. U.S. 2013/0333842; 2015/0259970; and 2016/0340962, which are assigned to the assignee of the present disclosure. The above U.S. Patent Publications, namely U.S. 2013/0333842; 2015/0259970; and 2016/0340962 are incorporated herein by reference in their entirety and for all purposes.

### SUMMARY

One or more example embodiments of the present disclosure includes a threaded insulating glass unit plug for sealing an aperture in a spacer frame of an insulating glass unit, a method of fabricating the plug, and a method of installing the plug into a spacer frame of an insulating glass unit. The threaded insulating glass unit plug includes a head integrally formed with threaded body. The head has a recess formed for engaging a tool for installation during use. The body includes a cylindrical portion and a conical portion, the cylindrical portion spacing the conical portion from the head. A plurality of threads extend along the entire length of cylindrical portion engage a backside of the head and one or more threads extending at least along a section of the conical portion. to.

Another example embodiment of the present disclosure includes a method for forming a threaded insulating glass unit plug for sealing an aperture in a spacer frame of an insulating glass unit, the method comprising integrally forming a head with a threaded body, the threaded body having a cylindrical portion and a conical portion, the cylindrical portion spacing the conical portion from the head, forming a recess for engaging a tool for installation during use in the head, and forming a plurality of threads along the entire length of cylindrical portion to engage a backside of the head and at least one thread extending along a portion of the conical portion.

Another example embodiment of the present disclosure includes a system for installation of a threaded insulating glass unit plug, the threaded insulating glass unit plug for sealing an aperture in a spacer frame of an insulating glass unit, the system comprising one or more threaded insulating glass unit plugs, a feeder bowl comprising at least one of an oscillator and vibratory coil that advances individually the one or more threaded insulating glass unit plugs around a track to orient an individual plug of the one or more threaded insulating glass unit plugs in a uniform orientation relative to others of the one or more threaded insulating glass unit plugs, the uniform orientation comprising the conical portions of the one or more threaded insulating glass unit plugs being oriented in a same direction, and an automatic plug gun functionally coupled to the track, wherein the one or more oriented threaded insulating glass unit plugs having the uniform orientation are fed into the automatic plug gun. The threaded insulating glass plug comprising a head integrally formed with a body, the head having a recess formed for engaging a tool for installation during use, and the body having a cylindrical portion, a conical portion, and a plurality of threads that extend along the entire length of cylindrical portion to engage a backside of the head and at least one thread located on a portion of the conical portion.

### BRIEF DESCRIPTION OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals refer to like parts unless described otherwise throughout the drawings and in which:

FIG. 1′ is an insulating glass unit as known in the prior art;

FIG. 2′ is a section view of FIG. 1′ along section lines 2-2;

FIG. 3′ is an assembly view of FIG. 2′;

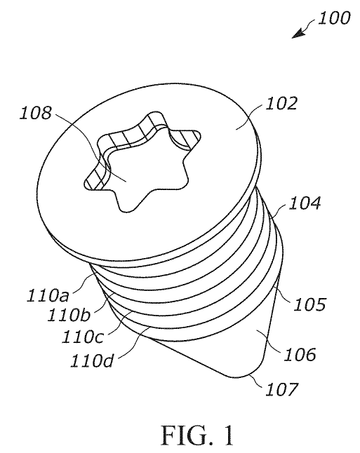

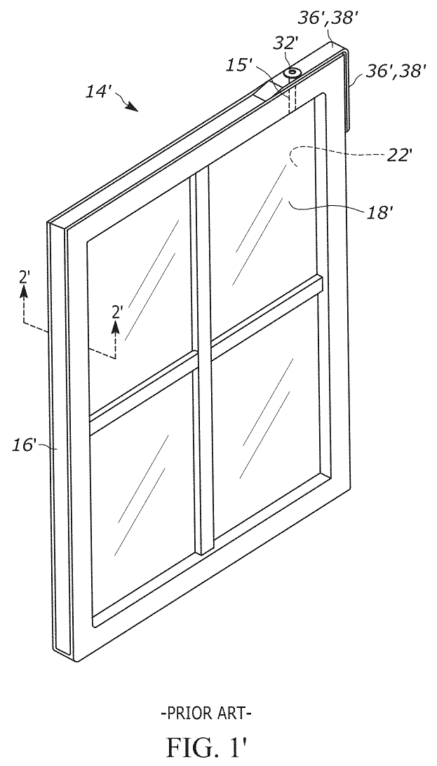

FIG. 1 is a perspective view of a threaded insulating glass unit plug constructed in accordance with one example embodiment of the present disclosure;

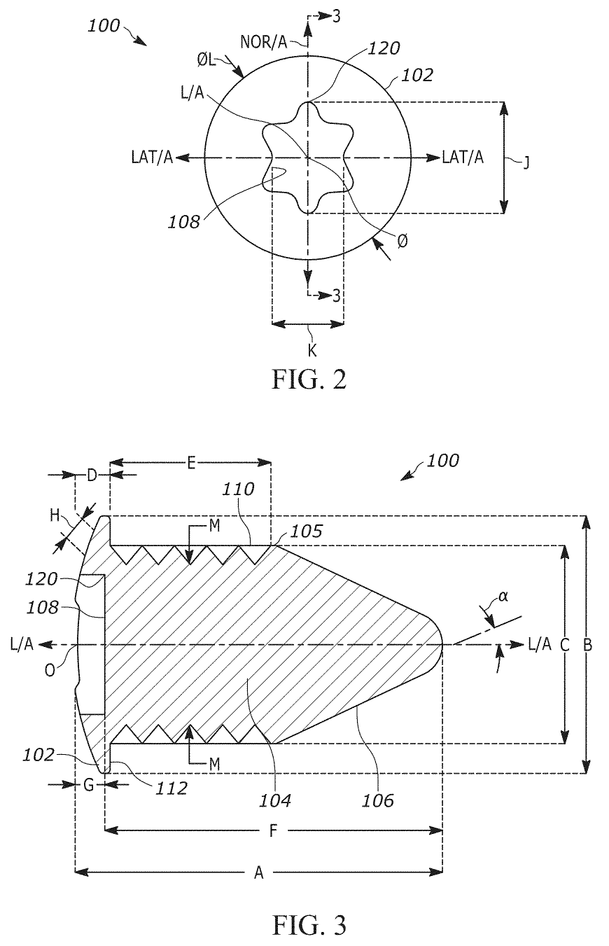

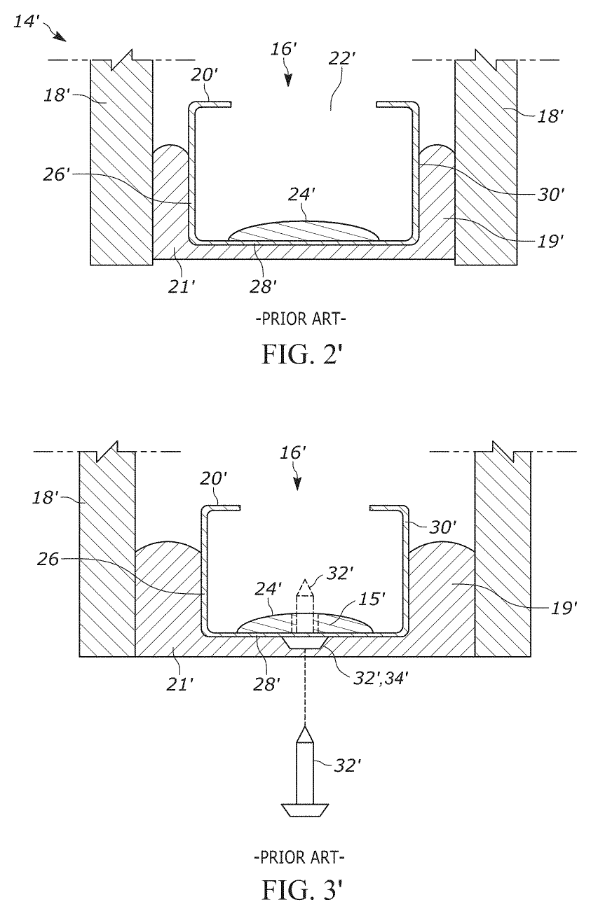

FIG. 2 is a top plan view thereof;

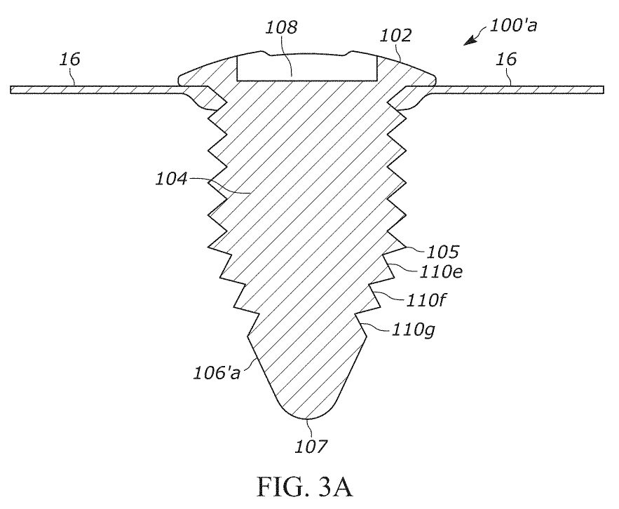

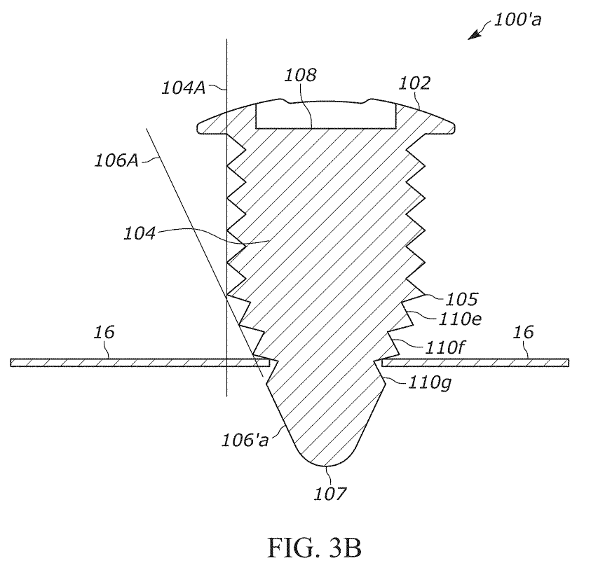

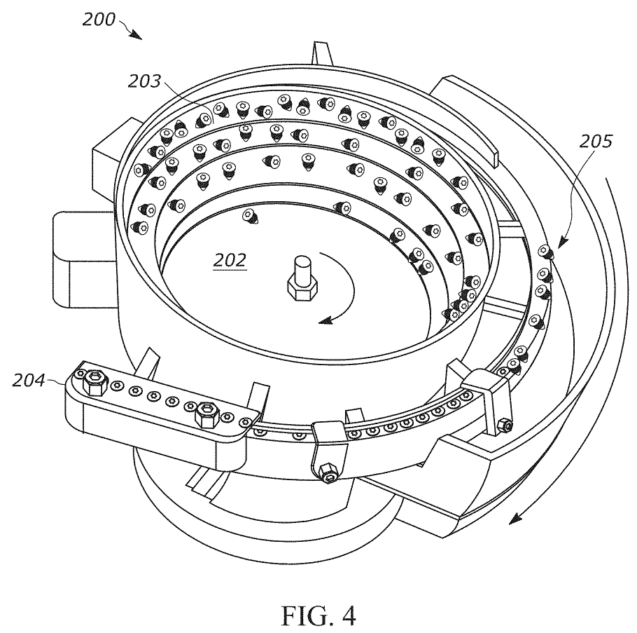

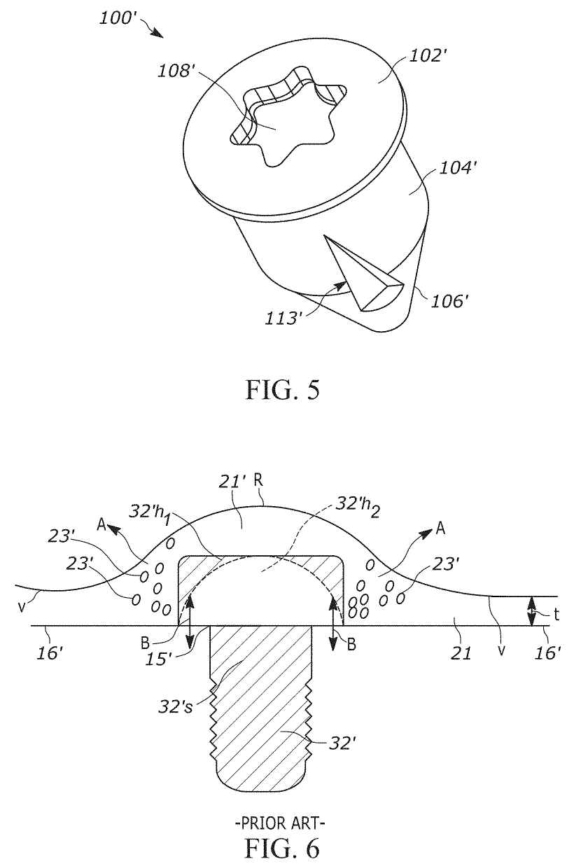

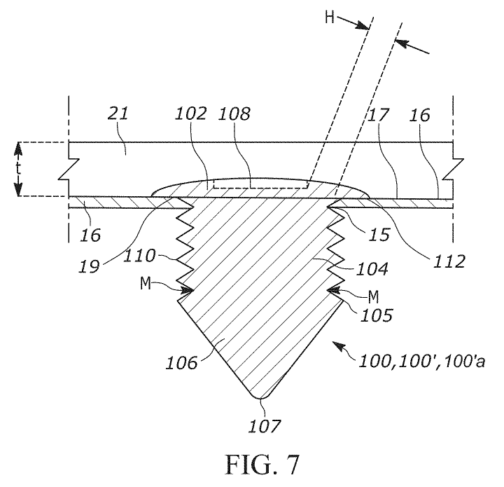

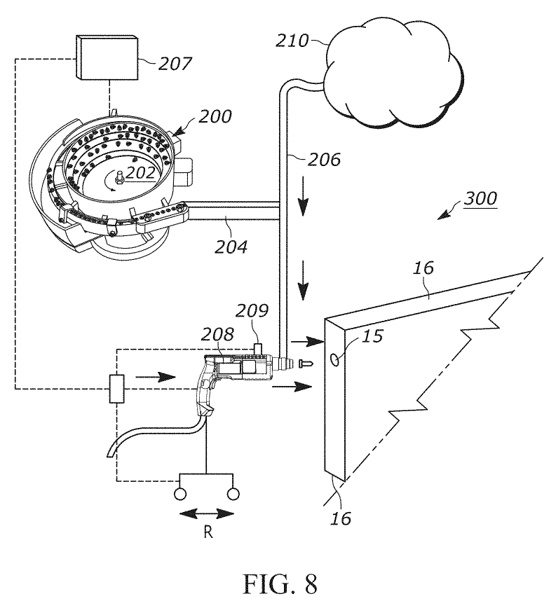

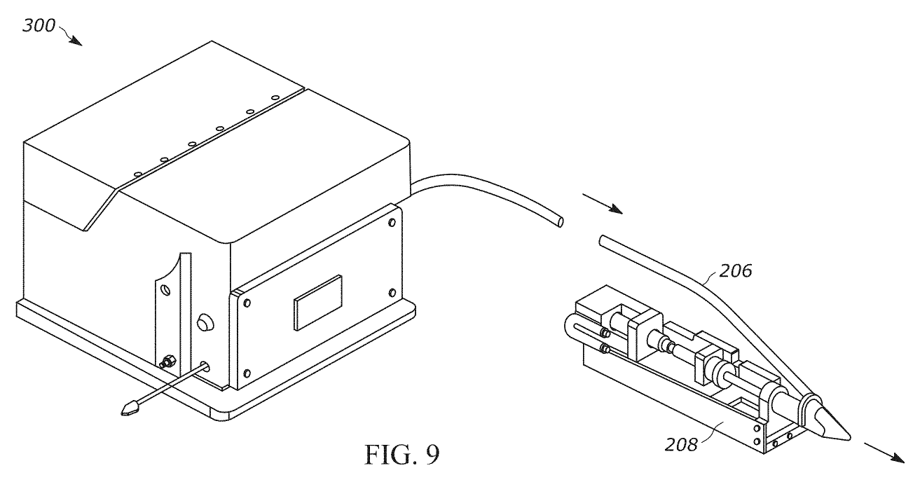

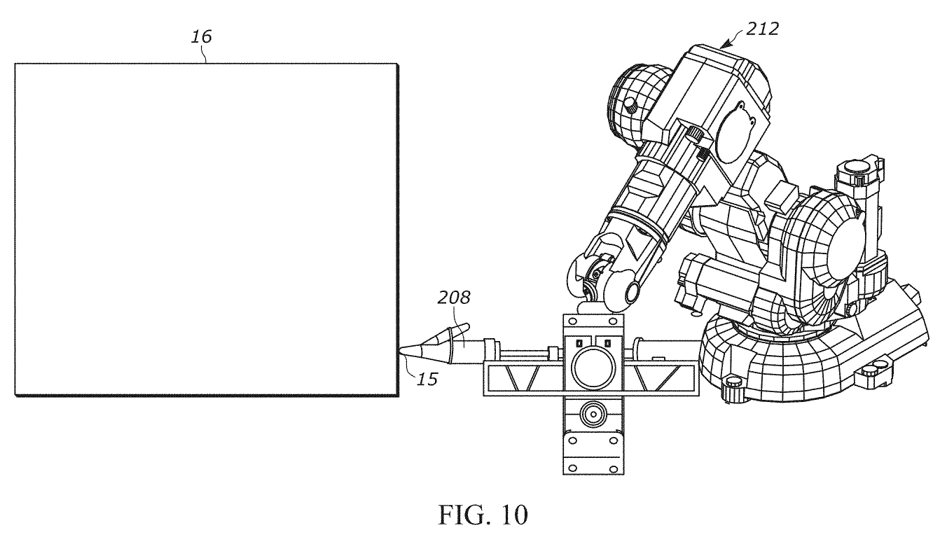

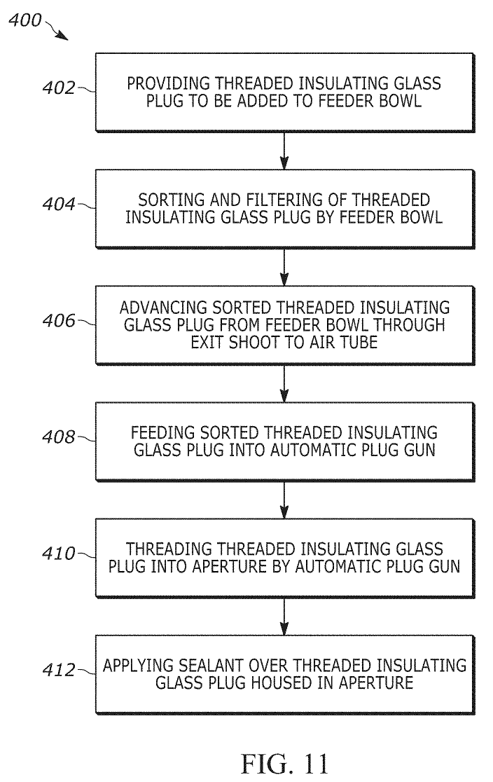

FIG. 3 is a section view of FIG. 2 along section lines 3-3 in accordance with one example embodiment of the present disclosure;

FIG. 3A is a section view of FIG. 2 along section lines 3-3, wherein the threaded insulating glass unit plug constructed in accordance with another example embodiment of the present disclosure and is illustrated as being installed in a spacer frame;

FIG. 3B is a section view of FIG. 2 along section lines 3-3, wherein the threaded insulating glass unit plug constructed in accordance with another example embodiment of the present disclosure and is illustrated as being partially installed in a spacer frame, in accordance with another example embodiment of the present disclosure;

FIG. 4 is a feeder bowl used to filter the insulating glass unit plugs in accordance with one example embodiment of the present disclosure;

FIG. 5 is a perspective view of a threaded insulating glass unit plug constructed in accordance another example embodiment of the present disclosure;

FIG. 6 illustrates the sealing of a rivet or screw to a spacer frame as known in the prior art;

FIG. 7 illustrates the sealing of a threaded insulating glass plug into a spacer frame in accordance with one example embodiment of the present disclosure;

FIG. 8 illustrates an assembly for automatically filtering a threaded insulating glass plug in a feeder bowl, feeding the plug into a supply line, loading the plug into an automatic plug gun, and automatically indexing the plug gun to thread the plug into a spacer frame in accordance with one example embodiment of the present disclosure;

FIG. 9 illustrates an automatic gun coupled to a filtering bowl by a supply line, in accordance with one example embodiment of the present disclosure;

FIG. 10 illustrates an assembly for automatically indexing a plug gun to thread a plug into a spacer frame in accordance with one example embodiment of the present disclosure; and

FIG. 11 a flow diagram of a method of plug sorting, indexing, and installation.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements throughout unless otherwise noted. The present disclosure relates to an insulating glass unit plug and installation method, and more particularly, a threaded insulating glass unit plug constructed for orientation filtering, allowing automatic installation.

FIG. 1′ illustrates one example of an insulating glass unit 14′ (IGU) as found in U.S. Patent Publication No. 2015/0259970, which is assigned to the assignee of the present application and incorporated herein by reference in its entirety and for all purposes. The IGU 14′ is gas sealed, as illustrated in FIG. 1′. The IGU 14′ comprises a spacer assembly 16′ sandwiched between glass sheets, panes, or lites 18′. Referring to FIGS. 2′ and 3′, the illustrated spacer assembly 16′ includes a frame structure 20′ (typically made from metal, such as steel or aluminum), a sealant material 19′ for hermetically joining the frame to the lites 18′ to form a first seal 21′, and a closed space 22′ within the IGU 14′. A body of desiccant 24′ is provided in the closed space 22′. The IGU 14′ illustrated by FIG. 1′ is in condition for final assembly into a window or door frame. It is also contemplated that the disclosed apparatus may be used to construct an insulated window with panes bonded directly to sash elements of the window, rather than using an IGU that is constrained by the sash.

It should be readily apparent to those skilled in the art that the disclosed apparatus and method can be used with spacers other than the illustrated spacer. For example, a closed box shaped spacer, any rectangular or polygonal shaped spacer, any foam composite spacer or any alternative material can be used. It should also be apparent that the disclosed apparatus and method can be used in IGUs having any shape and size.

The glass lites 18′ are constructed from any suitable or conventional glass. The glass lites 18′ may be single strength or double strength and may include low emissivity coatings. The glass lites 18′ on each side of the IGU 14′ need not be identical, and in many applications different types of glass lites are used on opposite sides of the IGU. The illustrated lites 18′ are rectangular, aligned with each other, and sized so that their peripheries are disposed just outwardly of the frame structure 20′ outer periphery.

The spacer assembly 16′ functions to maintain the lites 18′ spaced apart from each other and to produce the hermetic insulating air space 22′ between the lites. The frame 20′ and sealant 19′ cooperate to provide a structure which maintains the lites 18′ properly assembled with the space 22′ sealed from atmospheric moisture over long time periods during which, the insulating glass unit 14′ is subjected to frequent significant thermal stresses. The desiccant body 24′ serves to remove water vapor from air or other gases entrapped in the space 22′ during construction of the IGU 14′ and any moisture that migrates through the sealant 19′ over time.

The sealant 19′ both structurally adheres the lites 18′ to the spacer assembly 16′ and hermetically closes the space 22′ against infiltration of air born water vapor from the atmosphere surrounding the IGU 14′ and further keeps insulating gasses, such as argon, from diffusing out of the closed space. A variety of different sealants may be used to construct the IGU 14′. Examples include hot melt sealants, dual seal equivalents (DSE), and modified polyurethane sealants. In the illustrated embodiment, the sealant 19′ is extruded onto the frame 20′. This is typically accomplished, for example, by passing an elongated frame (prior to bending into a rectangular frame) through a sealant application station, such as that disclosed by U.S. Pat. No. 4,628,528 assigned to the assignee of the present disclosure. Although a hot melt sealant is disclosed, other suitable or conventional substances (individually or in combination) for sealing and structurally carrying the unit components together may be employed without departing from the spirit of the present disclosure.

Referring to FIGS. 2′ and 3′, the illustrated frame 20′ is constructed from a thin ribbon of metal, such as stainless steel, tin plated steel or aluminum. For example, 304 stainless steel having a thickness of 0.006-0.010 inches may be used. The ribbon is passed through forming rolls (not shown) to produce walls 26′, 28′, 30′. In the illustrated embodiment, the desiccant 24′ is attached to an inner surface of the frame wall 26′. The desiccant 24′ may be formed by a desiccating matrix in which a particulate desiccant is incorporated in a carrier material that is adhered to the frame 20′. The carrier material may be silicon, hot melt, polyurethane or other suitable material. The desiccant 24′ absorbs moisture from the surrounding atmosphere for a time after the desiccant is exposed to atmosphere. The desiccant 24′ absorbs moisture from the atmosphere within the space 22′ for some time after the IGU 14′ is fabricated. This assures that condensation within the IGU 14′ does not occur. In the illustrated embodiment, the desiccant 24′ is extruded onto the frame 20′.

To form an IGU 14′ the lites 18′ are placed on the spacer assembly 16′. The IGU 14′ is heated and pressed together to bond the lites 18′ and the spacer assembly 16′ together. Once the IGU frame has been pressed, an aperture 15′ is drilled or punched along one end of the frame structure 20′ through the first seal 21′ and sealant 19′, as illustrated in FIGS. 1′ and 3′. In an alternative example embodiment, the aperture 15′ may be drilled or punched into the frame 20′ before the sides 26′, 28′, and 30′ are formed or before it is formed into a rectangular frame. The aperture 15′ is used to fill the IGU 14′ with gas to improve the insulation properties or quality of the unit. Once the IGU 14′ is filled with gas, a rivet or fastener 32′, such as a screw, is placed into the aperture 15′ as a primary seal 34′. A hot sealant 36′ acting as a second or outer gas seal 38′ is then automatically applied over the fastener 32′ (e.g., as illustrated in FIG. 3′) by a method 400 and the assembly 16′ as further described below. While the hot sealant 36′ acting as the outer gas seal 38′ is illustrated in FIG. 1′ as being over the fastener 32′ and extending around the adjacent corner, it would be appreciated that the hot sealant 36′ may be applied solely over the fastener 32′ and the area adjacent to the fastener, without extending around the adjacent corner.

While the current example embodiment illustrates an IGU 14′ comprising a double pane, i.e. dual lites 18′, one lite on each side of the frame 20′, one or more apertures 15′ can exists on an IGU, for example in a triple pane IGU. Further discussion of a multi-frame IGU is found in U.S. Pat. No. 9,416,583, which is assigned to the assignee of the present application. U.S. Pat. No. 9,416,583 is incorporated herein by reference in its entirety and for all purposes.

Referring now to FIG. 1 is a perspective view of a threaded insulating glass unit plug 100 constructed in accordance with one example embodiment of the present disclosure. In the illustrated example embodiment, the threaded insulating glass unit plug 100 is made from metal. However, it should be appreciated that the threaded insulating glass unit plug 100 can be made of other materials of similar hardness and/or strength such as rigid plastic.

The threaded insulating glass unit plug 100 comprises a head 102, body 104, conical member 106, recess 108, and threads 110. Illustrated in FIG. 2 is a top or plan view of the plug 100 shown in FIGS. 1, 3A, and 3B. The plug 100 of FIG. 2 illustrates a lateral axis (LAT/A) that is orthogonal to a normal axis (NOR/A). Illustrated in FIG. 3 is a section view of the plug 100 in FIG. 2 along section lines 3-3 in accordance with one example embodiment. The section view illustrates a longitudinal axis (L/A) that is orthogonal to both the LAT/A and the NOR/A all intersecting at intersection point (“O”).

In one example embodiment, the plug 100 is made from metals suitable for cold forming or cold heading, and the recess 108 is cold formed into the head 102. The body 104 during the cold forming process is oversized so that threads can be cut or turned into the body as would be appreciated by one of ordinary skill in the art. In the illustrated example embodiment, the threads are turned from a first end 105 of the conical member 106 all the way to a backside 112 of the head 102 where the body 104 engages or extends from the head. The head 102 and body 104 are formed at the same time from a single slug to make an integral or unitary element that cannot be separated without destruction.

In the illustrated example embodiment, the thread size cut or turned on the body 104 is a #10-32 UNF×Ø 5/16, which accommodates the spacer frame 16 metal thickness and aperture opening 15 found on a conventional IGU. However, it should be appreciated that other thread sizes, cuts, and body diameters could be used without departing from the spirit and scope of the present disclosure.

Table 1 illustrates the various averages, maximum, and minimum lengths (inches) and angles (degrees) of the dimensions designed for of the plug 100 illustrated in FIGS. 1-3 that allows for maximum sealing of an IGU as well automatic filtering of the plugs 100 in for example, a feeder or vibrating bowl 200 illustrated in FIG. 4. In order to optimize the automatic filtering and sealing capabilities of the IGU, the plug 100 is based on the dimensions below, and using the average measurement, maintains a desired ratio of the Head Thickness to Minor Diameter of the body 104 (hereinafter “D/C”) to be 15.9% and no greater than 17%. The sealing capabilities of the IGU 14 are also optimized by the construction of the plug 100. The construction of the plug 100 is based on the dimensions below. For example, the depth of the recess 108 cannot be less than 0.028″ (inches) however, the recess depth cannot exceed the head 102 thickness, ranging between 0.03125″ (inches) and 0.028″ (inches). In another example embodiment, the recess depth G to head thickness D (hereinafter “G/D”) ranges between 90% and 100%

In order to maximize the sealing capabilities of the IGU 14 and the structural integrity of the plug 100, the recess 108, and its relatively short depth, requires in the illustrated example embodiment, a hexalobular drive shape that can be used in an automatic plug gun. It should be appreciated that other tool connections can be used without departing from the spirit and scope of the claimed disclosure, including, but not limited to hexagonal, Philips, straight, and the like.

As shown in the illustrated example embodiment of FIG. 2, the recess 108 lobes located about the Outer Diameter J, when formed in the head 102 of the plug, is a controlled dimension along with the recess depth as mentioned above. The lobe of the recess 108 formed in the Outer Diameter J prevents an area of weakness, which requires a controlling of the undercut dimension H, illustrated in FIG. 3 and Table 1 below. The undercut dimension H is the linear passage between the recess 108 cavity Outer Diameter lobe 120 and the minor diameter M formed by the cutting of the threads 100. In the illustrated example embodiment, the undercut dimension H is held at 0.0219″ inches with a minimum amount being 0.0214″ inches. Holding such dimensions between the recess depth G, lobe location J, and minor thread diameter M, mitigates the risk of breaking of the head 102 from the body 104.

TABLE 1

| Dimension | Name | Avg. (in/°) | Max. (in/°) | Min. (in/°) |
|---|---|---|---|---|
| A | Total Length | .329 | .344 | .314 |
| B | Major Dia. | .240 | .245 | .235 |
| C | Minor Dia. | .186 | .190 | .183 |
| D | Head Thick. | .0296 | .03125 | .028 |
| E | Thread Len. | .150* | — | — |
| F | Body Len. | .298 | .313 | .283 |
| G | Recess Depth | .0296 | .03125 | .028 |
| H | Rec./Thd | .0219 | .0224 | .0214 |
| J | Recess O/D | .1318 | .1323 | .1313 |
| K | Recess I/D | .0944 | .0949 | .0939 |
| ØL | Head Dia. | .240 | .245 | .235 |
| M | Thread MDia | .152 | .157 | .147 |
| α | Conical Ang. | 22.5 | 25 | 20 |

Illustrated in FIGS. 3A-3B is a threaded insulating glass unit plug 100′a constructed in accordance with another example embodiment of the present disclosure. The threaded insulating glass unit plug 100′a is similar in construction to plug 100 previously described except that the plug 100′a further comprises threads 110e, 110f, 110g along the conical member 106′a. In this example embodiment, the body 104 and the conical member 106′a during the cold forming process are oversized so that threads can be cut or turned into the body and conical member as would be appreciated by one of ordinary skill in the art. In the illustrated example embodiment of FIGS. 3A-3B, the threads 110a-110g are turned from at or near a second end 107 of the conical member 106′a all the way to the backside 112 of the head 102.

The threading 110e, 110f, 110g extending onto the conical member 106′a assists/facilitates consistent engagement of the screw 100′a with the spacer frame 16 during the threading process. Stated another way, the threads cut or turned, or formed into the conical member 106 allows the plug 100′ to reduce the likelihood of spin-out upon engaging an aperture and more consistently engage the opening such that the plug is drawn inward with a self-tapping or drilling connection. In the illustrated example embodiment of FIG. 3B, the threads on the conical member 106′ are transverse to the threads on the body 104′ as indicated by lines 104A and 106A, enhancing the strength the of connection between the plug 100′ and the spacer frame 16.

Illustrated in FIG. 5 is a threaded insulating glass unit plug 100′ constructed in accordance with another example embodiment of the present disclosure. The threaded insulating glass unit plug 100′ is similar in construction as plug 100 previously described except the plug 100′ further comprises at least one transverse cut 113′ either extending or recessed into the body 104′ and/or conical member 106′. The one or more transverse cuts 113′ equally spaced and shaped around the body 104′ provide for a self-tapping plug into a smaller opening 15 in the spacer frame 16 than the size of the diameter of the body. In one example embodiment, the self-tapping ability of the plug 100′ provides a greater seal with the spacer frame 16 as the frame metal is pulled to the backside 112 of the head 102.

FIG. 6 illustrates the sealing of a rivet or screw 32′ to a spacer frame 16′ as known in the prior art. In particular, the screw 32′ whether a socket-head cap screw 32′h₁ or pan-head screw 32′h₂ (shown in dashed lines) the following problems are encountered and resolved by the threaded insulating glass unit plugs 100 and 100′ of the present disclosure.

A first problem results from the passage of the sealant over the screw 32′. Sealant 20′ is used to prevent the transfer of gas or fluid to the center of the spacer frame 16′ and applied at a desired thickness “t”. Undesirably, the head of the screw 32′ creates valleys “V” and a rise “R” in the sealant 21′ as it passes over the head of the screw. As a result, the valleys V changing to the rise R in the sealant 21′ creates air pockets or air bubbles 23′ that are undesirable. These air pockets or bubbles 23′ are denser in at the corners formed by interaction of the screw 32′ head and spacer frame 16′. The air bubbles 23′ permeate outwardly (see arrows A in FIG. 6) over time through the sealant 21′, creating a leak path through the sealant. Undesirably, this leak path allows for the evacuation or infiltration of gas and/or fluid into the center of the spacer frame 16′, often causing humidity or moisture to destroy or obscure viewing through the window, as well imports a break down in insulation or increase in heat transfer.

A second problem results from the screw 32′h₁ or 32′h₂ having a shank or space 32's that is not threaded. Thus, the screw 32′ can move in and out of the spacer frame 16′ over time, allowing for the passage of fluid and/or gas through the sealant (see arrows B).

The construct of the threaded insulating glass unit plug 100 and 100′ resolve such problems by their construction illustrated in FIGS. 1-3, 5, and 7 and by the dimensions/ratios described or referred to in Table 1. This is further appreciated when referring to FIG. 7, which illustrates the sealing of a threaded insulating glass plug 100, 100′, 100′a into a spacer frame 16 through aperture 15 in accordance with one example embodiment of the present disclosure. The sealant 21 is applied over the head 102 of the plug 100, 100′, 100′a at a desired thickness t. Because of the low profiled design of the plug head 102 (as further detailed by the dimensions in Table 1 and ratios further described above), the creation of air bubbles is nonexistent, as seen in FIG. 7. Moreover, a large overhang 19 of the head 102 provides a greater seal between the aperture 15 and the plug 100, 100′, 100′a. As well, the threads extending into the backside 112 of the head 102 allows the plug 100, 100′, 100′a to be drawn into the spacer frame 16, forming a gas and/or fluid tight seal.

Further illustrated in FIG. 7 is the recess 108 set or cold headed/formed in the head 102 and the undercut H proximity to the minor thread diameter M. The spacing and design of the undercut design H is shown in FIG. 7 and as further discussed by the ratios and dimensional relationships/dimensions illustrated in Table 1. The undercut design H prevents failure to the head 102 and body 104 during assembly, particularly during automatic assembly by a plug gun through over torquing.

FIG. 8 illustrates an assembly 300 for automatically filtering a threaded insulating glass plug 100, 100′ in a feeder bowl 200, feeding the plug into a supply line 206 from the feeder bowl exit track or exit shoot 204, loading the plug into an automatic plug gun 208, and automatically indexing the plug gun (from a first and a second position indicated by arrows R) to engage aperture 15 in a spacer frame 16 and thread the plug into spacer frame 16 in accordance with one example embodiment of the present disclosure. The details of a feeder bowl are further illustrated in FIG. 4 in which the plugs 100, 100′, 100′a are loaded into the base or hopper portion 202 of the bowl. The bowl 200 comprises an oscillator or vibratory coil that advances individually the plugs 100, 100′, 100′a around a track 203 (in a clockwise or counter clockwise direction) to the exit shoot 204. The ratio of the minor diameter B to the major diameter C (hereinafter “B/C”) and/or major diameter B to the body length F (hereinafter “B/F”) are both specifically constructed to make it possible for filtering or sorting the plugs 100, 100′, 100′a with a feeder bowl 200, the ratios being approximately 77.5% and 80.5%, respectively (see FIG. 3).

Referring to FIGS. 8-10, the plug 100, 100′, 100′a once it escapes the exit track 204, it is advanced away from the bowl 200 by pressure and/or air flow from an air tube 206 coupled to an air supply 210. The air tube 206 feeds into the automatic plug gun 208 so that the plug 100, 100′, 100′a is in the proper orientation such that the conical section 106 first enters the aperture 15 of the spacer frame 16. The automatic plug gun 208 in one example embodiment is guided by a vision system to align the plug 100, 100′ with the aperture 15. In another example embodiment, the automatic plug gun 208 uses fixturing for alignment and is indexed by a servo motor illustrated by arrows R in FIG. 8. In yet another example embodiment, the plugs 100 and 100′ are supplied to the plug gun 208 by a preloaded magazine.

In the illustrated example embodiment of FIG. 10, the plug gun 208 is supported by a robotic articulating arm 212, such as a six axis articulating arm as disclosed in U.S. Pat. Pub. No. 2018/0339307, which is incorporated herein in its entirety and for all purposes. The articulating arm 212 further includes tool support assemblies (e.g., an assembly that supports and moves the plug gun 208). In this example embodiment, the robotic articulating arm 212 will selectively couple to the plug gun 208, and align the plug gun with the aperture 15 utilizing the vision system (e.g., optical sensors, proximity sensors, etc.).

In one example embodiment, the automatic plug gun 208 is servo controlled by a remote controller or PLC 207 that regulates the amount of torque applied to the plug 100, 100′, 100′a preventing striping of the spacer frame 16 or fracturing of the recess 108 by over-torquing and preventing the plug from obtaining a full seat or nesting to a fluid-tight seal on the spacer frame from under torquing. In yet another example embodiment, the self-tapping plug 100′, 100′a enters an aperture 15 that is smaller than the body 104′, thus drawing the spacer frame 16 against the backside 112 of the head 102 to form a complete gas/fluid seal with the spacer frame. While yet in another example embodiment the PLC 207 is part of a feed-back loop with the motor in the gun 208 such that torque is optimized for sealing the spacer frame but not fracturing the plug head or stripping the thread from the spacer frame. This would allow a smart loop such that the plug is not over or under torqued.

In another example embodiment, the threads 110 of the plug 100, 100′, 100′a are hardened by a separate manufacturing process, such as, heat treatment, carburizing, zinc electroplating and the like. In some embodiments, the threaded insulating glass plugs 100, 100′, 100′a are plated with zinc and/or other commodity electroplating material, wherein the plating is alterable to match/conform to/resemble the spacer frame 16.

In the illustrated example embodiment of FIG. 11, a method 400 of using the automatic plug gun 208 is described. At 402, the threaded insulating glass plug 100, 100′, 100′a is added to the feeder bowl 200. At 404, the feeder bowl 200 sorts and filters the threaded insulating glass plugs 100, 100′, 100′a, as described above, based upon the ratios and design of said plugs. For example, the threaded insulating glass plugs 100, 100′, 100′a are oriented/sorted such that the conical portion 106, 106′, 106′a of the plugs are uniformly oriented in a same direction 205 (see FIG. 4). At 406, the threaded insulating glass plugs 100, 100′, 100′a having been sorted within the exit shoot 204, are advanced through the exit shoot 204 and into the air tube 206. At 408, the sorted and/or oriented threaded insulating glass plugs 100, 100′, 100′a are fed into the automatic plug gun 208 (e.g., through a lateral opening, wherein the plug enters the gun at an angle transverse to the alignment indicated by arrow R, through a rear opening that is substantially parallel to the alignment indicated by arrow R, etc.). At 410, the automated plug gun 208 threads, or the like, the threaded insulating glass plugs 100, 100′, 100′a into the aperture 15. At 412, hot sealant 36′ acting as a second or outer gas seal 38′ is then automatically applied over the fastener 32′ (e.g., as illustrated in FIG. 3′). A method of automatically applying hot sealant 36′ over a plug is disclosed in U.S. Pat. Pub. No. 2018/0339307, which is incorporated herein in its entirety and for all purposes.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%. The term “coupled” as used herein is defined as connected or in contact either temporarily or permanently, although not necessarily directly and not necessarily mechanically. A device or structure that is “configured” in a certain way is configured in at least that way, but may also be configured in ways that are not listed.

To the extent that the materials for any of the foregoing embodiments or components thereof are not specified, it is to be appreciated that suitable materials would be known by one of ordinary skill in the art for the intended purposes. Any reference cited in this application is incorporated by reference for all purposes and in its entirety.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A threaded insulating glass unit plug for sealing an aperture in a spacer frame of an insulating glass unit, the threaded insulating glass unit plug comprising:
a head integrally formed with threaded body, the head having a recess formed for engaging a tool for installation during use;
the body having a cylindrical portion and a conical portion, the cylindrical portion spacing the conical portion from the head; and
a plurality of threads that extend along the entire length of cylindrical portion to engage a backside of said head and at least one annular thread extending around a portion of the conical portion.

2. The threaded insulating glass unit plug of claim 1 further comprising a ratio of head thickness to minor diameter of said body to not exceed seventeen (17%) percent.

3. The threaded insulating glass unit plug of claim 1 wherein a ratio of a depth of said recess to a material thickness of said head ranges between ninety (90%) and one-hundred (100%) percent.

4. The threaded insulating glass unit plug of claim 1 wherein said recess is a hexobular recess for receiving a tool during installation into a spacer frame of an insulating glass unit.

5. The threaded insulating glass unit plug of claim 4 wherein the hexobular recess comprises inner lobes and outer lobes, wherein the inner lobe defines an inner diameter and the outer lobes define an outer diameter, the outer diameter is greater than the inner diameter, and further wherein a ratio of the inner diameter to the outer diameter is between about seventy (70%) and seventy-five (75%) percent.

6. The threaded insulating glass unit plug of claim 1 wherein said at least one annular thread extending around a portion of said conical portion comprises a plurality of threads forming a first plane along the major thread diameter and said plurality of threads that extend along the entire length of cylindrical portion form a second plane along the major thread diameter such that said first and second planes are transverse to each other.

7. The threaded insulating glass unit plug of claim 1 wherein a ratio of the minor diameter of the body to the major diameter of the body is approximately seventy-eight percent (78%).

8. The threaded insulating glass unit plug of claim 1 wherein a ratio of the major diameter of the body to the body length is approximately eighty-one percent (81%).

9. A method for forming a threaded insulating glass unit plug for sealing an aperture in a spacer frame of an insulating glass unit, the method comprising:
integrally forming a head with a threaded body, the threaded body having a cylindrical portion and a conical portion, the cylindrical portion spacing the conical portion from the head
forming a recess for engaging a tool for installation during use in the head; and
forming a plurality of threads along the entire length of cylindrical portion to engage a backside of said head and forming a plurality of threads along at least a portion of the conical portion.

10. The method of claim 9 the integrally forming a head further comprising forming the head to have a ratio of a head thickness to a minor diameter of said body that is less than or equal to seventeen (17%) percent.

11. The method of claim 9 the integrally forming a recess further comprising forming the recess to have a ratio of a depth of said recess to a material thickness of said head between ninety (90%) and one-hundred (100%) percent.

12. The method of claim 9 the integrally forming a recess comprising forming said recess as a hexobular recess for receiving the tool during installation into a spacer frame of an insulating glass unit.

13. The method of claim 9 the integrally forming a recess comprising forming a hexobular recess to comprise inner lobes and outer lobes, wherein the inner lobe defines an inner diameter and the outer lobes define an outer diameter, the outer diameter is greater than the inner diameter.

14. The method of claim 13 wherein forming the inner and outer lobes comprises forming a ratio of the inner diameter to the outer diameter between about seventy (70%) and seventy-five (75%) percent.

15. A system for installation of a threaded insulating glass unit plug, the threaded insulating glass unit plug for sealing an aperture in a spacer frame of an insulating glass unit, the system comprising:
one or more threaded insulating glass unit plugs, comprising:
a head integrally formed with a body, the head having a recess formed for engaging a tool for installation during use; and
the body having a cylindrical portion, a conical portion, and a plurality of threads that extend along the entire length of cylindrical portion to engage a backside of said head and a plurality of threads that extend along at least a portion of the conical portion, the cylindrical portion spacing the conical portion from the head;
a feeder bowl comprising at least one of an oscillator and vibratory coil that advances individually the one or more threaded insulating glass unit plugs around a track to orient an individual plug of the one or more threaded insulating glass unit plugs in a uniform orientation relative to others of the one or more threaded insulating glass unit plugs, the uniform orientation comprising the conical portions of the one or more threaded insulating glass unit plugs being oriented in a same direction; and
an automatic plug gun functionally coupled to the track, wherein the one or more oriented threaded insulating glass unit plugs having the uniform orientation are fed into the automatic plug gun.

16. The system of claim 15, wherein the head defines a major diameter of the body and the body portion defines a minor diameter, a ratio of a minor diameter of the body to a major diameter of the body is approximately seventy-eight percent (78%).

17. The system of claim 16, wherein the body extends away from the head along a longitudinal axis, the body comprises a body length that extends between the backside of the head to an opposing end of the conical portion, a ratio of the major diameter of the body to the body length is approximately eighty-one percent (81%).

18. The system of claim 15, wherein the automatic plug gun is coupled to the track by an air tube, the air tube fluidly coupled to an air supply, wherein the air supply provides a force to advance the one or more oriented threaded insulating glass unit plugs to the automatic plug gun, further wherein the air tube maintains the orientation of the one or more oriented threaded insulating glass unit plugs.

19. The system of claim 15, wherein the automatic plug gun is guided by a vision system to align the one or more oriented threaded insulating glass unit plugs with an aperture of a spacer frame.

20. The system of claim 15, wherein the automatic plug gun threadedly affixes a threaded insulting glass unit plug of the one or more oriented insulating glass unit plugs into the aperture conical portion first.
